(19) United States
(12) Patent Application Publication
(10) Pub. No.: US 2012/0169886 A1
(43) Pub. Date: Jul. 5, 2012

(54) SYSTEM AND METHOD FOR TESTING APERTURE OF IMAGE CAPTURING DEVICE

(75) Inventors: RUI-PING MA, Shenzhen City (CN); SHUANG PENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/304,413

(22) Filed: Nov. 25, 2011

(30) Foreign Application Priority Data
Dec. 31, 2010 (CN) 201010616892.X

(51) Int. Cl. H04N 17/00; H04N 5/76

(52) U.S. Cl. 348/187; 348/231.99; 348/E17.002

(57) ABSTRACT

In a method for testing an aperture of the image capturing device, a brightness value range of images is divided into a plurality of range intervals, and one of the range intervals is determined for testing the aperture. A brightness value of a current image captured by the image capturing device is calculated. A diameter of the aperture is controlled to increase or decrease to change the brightness value of the current image to be within the determined range interval, if the brightness value is not within the determined range interval. After the brightness of the current is changed to be within the determined range interval, if the brightness value of the current image has been changed during a predetermined time period, it is determined that the aperture does not work normally.

### BACKGROUND

1. Technical Field

Embodiments of the present disclosure relate generally to aperture testing technologies, and particularly to a system and method for testing an aperture of an image capturing device.

2. Description of Related Art

In an optics system or an image capturing device, such as a camera, an aperture is a hole or an opening through which light travels through. The aperture determines how many incoming rays are actually admitted and thus how much light reaches images captured by the image capturing device. Exposure for the images captured by the image capturing device is determined by the aperture. Since the image capturing device may not capture high quality images when the aperture cannot work normally, it is needed to test the aperture after the aperture is installed on the image capturing device.

### BRIEF DESCRIPTION OF THE DRAWINGS

FIG. 1 is a block diagram of one embodiment of an image capturing device including a testing system.

FIG. 2A and FIG. 2B illustrate one embodiment of a flowchart of a method for testing an aperture of the image capturing device using the test system of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

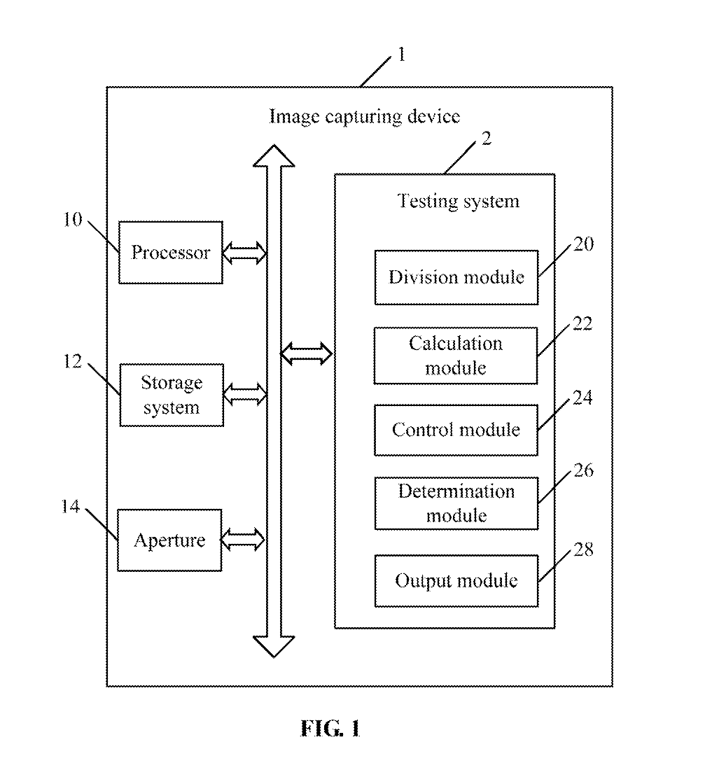

FIG. 1 is a block diagram of one embodiment of an image capturing device 1 including a testing system 2. The image capturing device 1 further includes a processor 10, a storage system 12, and an aperture 14. The testing system 2 tests if the aperture 14 works normally. It is understood that FIG. 1 is only one example of the image capturing device 1 that can include more or fewer components than those shown in the embodiment, or a different configuration of the various components.

The storage system 12 stores one or more programs, such as programs of a firmware or other applications of the image capturing device 1, and executed by the processor 10 to provide functions of the image capturing device 1. In one embodiment, the storage system 12 may be a random access memory (RAM) for temporary storage of information, and/or a read only memory (ROM) for permanent storage of information. In other embodiments, the storage system 22 may also be an external storage device, such as a flash memory, a storage card, or a data storage medium.

The testing system 10 may include a plurality of software programs in the form of one or more computerized instructions stored in the storage system 12, and executed by a processor 10, to perform operations of the image capturing device 1. In the embodiment, the testing system 10 includes a division module 20, a calculation module 22, a control module 24, a determination module 26, and an output module 28. In general, the word “module”, as used herein, refers to logic embodied in hardware or firmware, or to a collection of software instructions, written in a programming language, such as, Java, C, or Assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The division module 20 divides a brightness value range “0 to 255” of images into a plurality of range intervals, such as three range intervals which are [0, 85], [86, 170], and [171, 255]. When the brightness value range is divided, the division module 20 determines one of the range intervals for testing the aperture 14, such as a first range interval [0, 85] for testing the aperture 14.

The calculation module 22 calculates a brightness value of a current image captured by the image capturing device 1, and determines whether the brightness value is within the determined range interval. In one example, the calculation module 22 may obtain a brightness value of each of pixels of the current image, and then calculates an average brightness value of the pixels as the brightness value of the current image.

The control module 24 controls a diameter of the aperture 14 to increase or decrease, to change the brightness value of the current image to be within the determined range interval, if the brightness value is not within the determined range interval. In one embodiment, the control module 24 may control the diameter of the aperture 14 to increase or decrease using a particular drive circuit of the image capturing device 1 that is designed for the aperture 14.

The determination module 26 determines whether the brightness value of the current image is changed during a predetermined time period, such as three seconds, or five seconds. If the brightness value of the current image is not changed during the predetermined time period, another range interval is determined for testing the aperture until all of the range intervals are tested. If the brightness value of the current image is changed during the predetermined time period, the determination module 26 determines the aperture 14 does not work normally. In one embodiment, if the brightness value of the current image is within the determined range interval during the predetermined time period, the brightness may be regarded as not be changed.

The output module 28 generates test information of the aperture 14 after the aperture 14 is tested based on all of the range intervals, and stores the test information of the aperture 14 into the storage system 12. In addition, if the image capturing device 1 is connected to a computer or other computing device, the output module 28 may output the test information to the computer or the computing device, and display the test information on a display screen of the computer or the computing device. In one embodiment, the test information includes, for example, the range intervals, the calculated brightness value of the current image, and a test result (e.g., “pass” or “fail”) indicating whether the aperture 14 works normally.

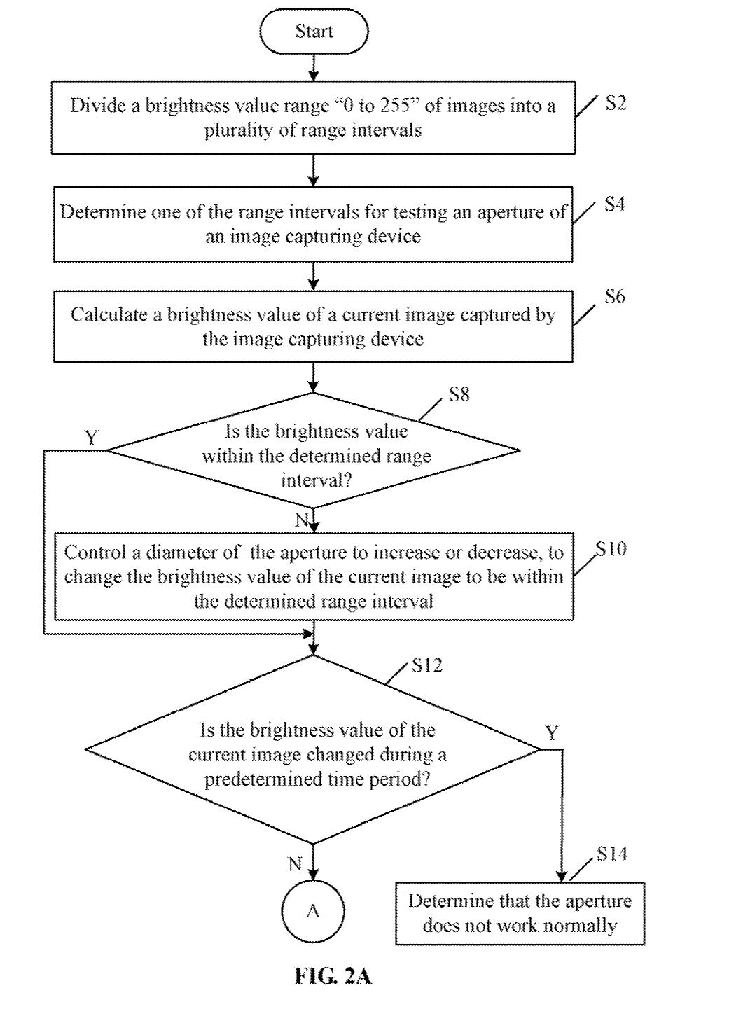

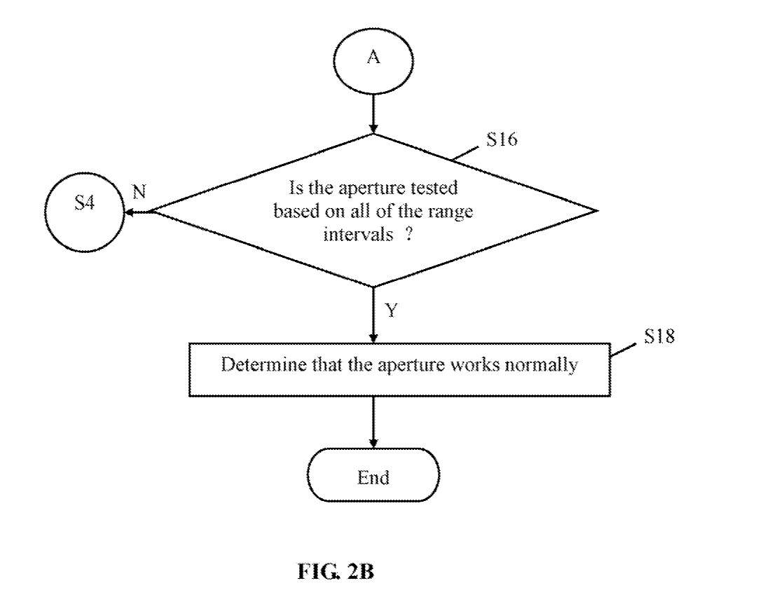

FIG. 2A and FIG. 2B illustrate one embodiment of a flowchart of a method for testing the aperture 14 of the image capturing device 1 using the test system 2 of FIG. 1. Depending on the embodiment, additional blocks may be added, others removed, and the ordering of the blocks may be changed.

In block S2, the division module 20 divides a brightness value range “0 to 255” of images into a plurality of range intervals, such as three range intervals which are [0, 85], [86, 170], and [171, 255].

In block S4, the division module 20 determines one of the range intervals for testing the aperture 14, such as a first range interval [0, 85] for testing the aperture 14.

In block S6, the calculation module 22 calculates a brightness value of a current image captured by the image capturing device 1. In one example, the calculation module 22 may obtain a brightness value of each of pixels of the current image, and then calculates an average brightness value of the pixels as the brightness value of the current image.

In block S8, the calculation module 22 determines whether the brightness value of the current image is within the determined range interval. If the brightness value of the current image is within the determined range interval, block S12 is implemented. If the brightness value of the current image is not within the determined range interval, block S10 is implemented.

In block S10, the control module 24 controls the diameter of the aperture 14 to increase or decrease, to change the brightness value of the current image to be within the determined range interval. In one embodiment, the control module 24 may control the diameter of the aperture 14 to increase or decrease using a particular drive circuit of the image capturing device 1 that is designed for the aperture 14.

In block S12, the determination module 26 determines whether the brightness value of the current image is changed during a predetermined time period, such as three seconds, or five seconds. If the brightness value of the current image has not been changed during the predetermined time period, block S16 is implemented. If the brightness value of the current image is changed during the predetermined time period, in block S14, the determination module 26 determines that the aperture 14 does work normally.

In block S16, the determination module 26 determines whether the aperture 14 has been tested based on all of the range intervals. If the aperture 14 has been tested based on all of the range intervals, in block S18, the determination module 26 determines that the aperture 14 works normally. If the aperture 14 has not been tested based on all of the range intervals, block S4 is repeated to determine another range interval for testing the aperture 14.

When the aperture 14 is tested based on all of the range intervals, the output module 28 generates test information of the aperture 14, and stores the test information of the aperture 14 into the storage system 12. In addition, if the image capturing device 1 is connected to a computer or other computing device, the output module 28 may output the test information to the computer or the computing device, and display the test information on a display screen of the computer or the computing device. In one embodiment, the test information includes, for example, the range intervals, the calculated brightness value of the current image, and a test result (e.g., “pass” or “fail”) that indicating whether the aperture 14 works normally.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computerized method for testing an aperture of an image capturing device, the method comprising:
dividing a brightness value range of images into a plurality of range intervals;
determining one of the range intervals for testing the aperture;
calculating a brightness value of a current image captured by the image capturing device, and determining whether the brightness value of the current image is within the determined range interval;
controlling a diameter of the aperture to increase or decrease, to change the brightness value of the current image to be within the determined range interval, if the brightness value is not within the determined range interval;
determining whether the brightness value of the current image is changed during a predetermined time period; and
determining that the aperture does not work normally if the brightness value of the current image is changed during the predetermined time period.

2. The method according to claim 1, further comprising:
determining whether the aperture has been tested based on all of the range intervals, if the brightness value of the current image has not been changed during the predetermined time period;
repeating the step of determining one of the range intervals for testing the aperture, to test the aperture based on another range interval, if the aperture has not been tested based on all of the range intervals; or
determining that the aperture works normally if the aperture has been tested based on all of the range intervals.

3. The method according to claim 2, further comprising:
generating test information of the aperture to indicate whether the aperture works normally;
storing the test information of the aperture into a storage system of the image capturing device; and
outputting the test information to a computing device connected to the image capturing device, and displaying the test information on a display screen of the computing device.

4. The method according to claim 1, wherein the brightness value of the current image is calculated by:
obtaining a brightness value of each of pixels of the current image; and
calculating an average brightness value of the pixels as the brightness value of the current image.

5. The method according to claim 1, wherein the diameter of the aperture is controlled to increase or decrease using a drive circuit of the image capturing device.

6. An image capturing device, comprising:
an aperture;
a storage system;
at least one processor; and
one or more programs stored in the storage system and being executable by the at least one processor, the one or more programs comprising:
a division module operable to divide a brightness value range of images into a plurality of range intervals, and determine one of the range intervals for testing the aperture;
a calculation module operable to calculate a brightness value of a current image captured by the image capturing device, and determine whether the brightness value of the current image is within the determined range interval;
a control module operable to control a diameter of the aperture to increase or decrease, to change the brightness value of the current image to be within the determined range interval, if the brightness value is not within the determined range interval; and
a determination module operable to determining whether the brightness value of the current image is changed during a predetermined time period, and determine that the aperture does not work normally if the brightness value of the current image has been changed during the predetermined time period.

7. The image capturing device according to claim 6, wherein the determination module further operable to determine whether the aperture has been tested based on all of the range intervals if the brightness value of the current image has not been changed during the predetermined time period, and determine that the aperture works normally if the aperture has been tested based on all of the range intervals.

8. The image capturing device according to claim 7, wherein the one or more programs further comprises:
an output module operable to generating test information of the aperture to indicate whether the aperture works normally, store the test information of the aperture into a storage system of the image capturing device, output the test information to a computing device connected to the image capturing device, and display the test information on a display screen of the computing device.

9. The image capturing device according to claim 6, wherein the brightness value of the current image is calculated by:
obtaining a brightness value of each of pixels of the current image; and
calculating an average brightness value of the pixels as the brightness value of the current image.

10. The image capturing device according to claim 6, wherein the diameter of the aperture is controlled to increase or decrease using a drive circuit of the image capturing device.

11. A non-transitory storage medium storing a set of instructions, the set of instructions capable of being executed by a processor of an image capturing device, cause the processor to perform a method for testing an aperture of the image capturing device, the method comprising:
dividing a brightness value range of images into a plurality of range intervals;
determining one of the range intervals for testing the aperture;
calculating a brightness value of a current image captured by the image capturing device, and determining whether the brightness value of the current image is within the determined range interval;
controlling a diameter of the aperture to increase or decrease, to change the brightness value of the current image to be within the determined range interval, if the brightness value is not within the determined range interval;
determining whether the brightness value of the current image is changed during a predetermined time period; and
determining that the aperture does not work normally if the brightness value of the current image is changed during the predetermined time period.

12. The non-transitory storage medium according to claim 11, wherein the method further comprises:
determining whether the aperture has been tested based on all of the range intervals, if the brightness value of the current image has not been changed during the predetermined time period;
repeating the step of determining one of the range intervals for testing the aperture, to test the aperture based on another range interval, if the aperture has not been tested based on all of the range intervals; or
determining that the aperture works normally if the aperture has been tested based on all of the range intervals.

13. The non-transitory storage medium according to claim 12, wherein the method further comprises:
generating test information of the aperture to indicate whether the aperture works normally;
storing the test information of the aperture into a storage system of the image capturing device; and
outputting the test information to a computing device connected to the image capturing device, and displaying the test information on a display screen of the computing device.

14. The non-transitory storage medium according to claim 11, wherein the brightness value of the current image is calculated by:
obtaining a brightness value of each of pixels of the current image; and
calculating an average brightness value of the pixels as the brightness value of the current image.

15. The non-transitory storage medium according to claim 11, wherein the diameter of the aperture is controlled to increase or decrease using a drive circuit of the image capturing device.
